(19) United States
(12) Patent Application Publication
(10) Pub. No.: US 2026/0299163 A1
(43) Pub. Date: Oct. 1, 2026

(54) PRODUCTION METHOD FOR AN OPTOELECTRONIC ELEMENT AND CORRESPONDING OPTOELECTRONIC ELEMENT

(71) Applicant: Robert Bosch GmbH, Stuttgart (DE)

(72) Inventors: Matthias Falk, Aichtal (DE); Soeren Sofke, Tuebingen (DE); Rainer Straub, Ammerbuch (DE)

(21) Appl. No.: 19/576,341

(22) Filed: Mar. 24, 2026

(30) Foreign Application Priority Data
Mar. 28, 2025 (DE) 10 2025 112 164.8

(51) Int. Cl. G02B 1/00

(52) U.S. Cl. CPC G02B 1/002

(57) ABSTRACT

A production method for an optoelectronic element and a corresponding optoelectronic element. The production method includes: providing a first wafer substrate having a first front side and a first rear side, wherein a plurality of optical metamaterial components is provided in or on the first wafer substrate; providing a second wafer substrate having a second front side and a second rear side, wherein a plurality of optical signal-processing components is provided in or on the second wafer substrate; wafer bonding the first rear side to the second front side in such a way that at least one associated optical metamaterial component is optically functionally assigned to each optical signal-processing component; and singulating the bonded first wafer substrate and second wafer substrate into a plurality of chips of optoelectronic elements, which in each case have an optical signal-processing component and at least one associated optical metamaterial component.

### CROSS REFERENCE

The present application claims the benefit under 35 U.S.C. § 119 of Germany Patent Application No. DE 10 2025 112 164.8 filed on March 28, 2025, which is expressly incorporated herein by reference in its entirety.

### FIELD

The present disclosure relates to a production method for an optoelectronic element and to a corresponding optoelectronic element.

FIG. 3 is a schematic cross-sectional view of an exemplary optoelectronic element for explaining the problem underlying the present disclosure.

In FIG. 3, the reference sign OES designates an exemplary optoelectronic element. The optoelectronic element OES has a carrier substrate SU, to which an optical receiver R is bonded. A functional substrate having a lens element LE, through which a light cone LK can be directed onto the optical receiver R, is mounted on the carrier substrate SU via a spacer HA.

Conventionally, classically ground/polished lenses are fabricated individually. A further handling step is required in order to supply the optics to the assembly (in the same fab, or in another fab, which in turn requires packaging). Subsequently, the optics are individually picked up, aligned and fastened in the optical system.

This requires:

a) a passive assembly: marks and stop surfaces for orientation, positioning and alignment on the optic and on the optical system. The achievable tolerances are limited.

b) an active assembly: the optic is illuminated and the image is captured with computer support. The optic is then aligned in such a way that the image satisfies the target function. Subsequently, the optic is fastened. As a result, high alignment accuracies can be achieved in the X, Y and Z directions. However, such active assembly is complex and time-consuming to perform and is therefore cost-intensive.

In both cases, the optics can only be processed sequentially.

The problem with the described production process lies in the limited accuracy of the tolerance chain TK: receiver R – carrier substrate SU – spacer HA – functional substrate FS having lens element LE. Thus, the production throughput is relatively low, and the optics must be designed for higher tolerances, which limits the optical performance that can be guaranteed.

For niche applications, optics are currently fabricated on a wafer. This wafer is then joined as a whole to another wafer (which can contain, e.g., further optics, emitters or receivers). Only then is singulation carried out. However, in this process, since the lens material is different from a semiconductor-based laser or a CMOS-based receiver used, fabrication and assembly cannot be carried out in one process.

Europe Patent Application No. EP 2 983 206 A1 describes a method for producing sensor chip assemblies, wherein the method comprises the steps of: joining a photodetector wafer and an optics wafer to one another, forming photodetectors on the photodetector wafer, and joining a circuit wafer to the photodetector wafer, which in turn is joined to the optics wafer, after the photodetectors have been formed on the photodetector wafer.

Metalenses are novel optical elements that do not focus light like conventional lenses, but are based on nanostructured surfaces. As a result, they can be up to 1000 times flatter and may in the future enable optical systems that are unprecedentedly compact, lightweight and cost-effective.

A metalens comprises a flat light-transmissive carrier material on which nanoscale elements of different dimensions have been formed in a sophisticated arrangement. If light is now sent through such a metasurface, the individual light waves are delayed to varying degrees at these elements. Behind the metasurface, the light waves then superimpose to form new wavefronts having different propagation directions. Specifically in the case of metalenses, these elements are designed and distributed so that the light converges behind them at a focal point, as in a conventional lens. In general, however, metasurfaces can also be designed so that they imitate the functionalities of other optical components, for example beam splitters, polarizers or diffraction gratings.

For this purpose, the individual elements of a metasurface must be significantly smaller than the wavelength of the light, for which reason high-resolution lithographic methods are used for their production. The metalenses demonstrated to date have often still been produced by electron beam lithography, wherein the desired structures must initially be written successively into a corresponding resist layer with an electron beam.

In general, such optical components made of artificially nanostructured media, in which the propagation properties of the light are substantially determined by the underlying structure thereof, are referred to as optical metamaterial components. Optical metamaterial components are produced, for example, on or embedded in glass wafers.

Ting Hu et al. describe in Nanophotonics 2020; 9(4): 823–830 "CMOS-compatible a-Si metalenses on a 12-inch glass wafer for fingerprint imaging."

### SUMMARY

The present disclosure provides a production method for an optoelectronic element and a corresponding optoelectronic element.

According to an example embodiment, a production method for an optoelectronic element is provided, comprising the following steps:

providing a first wafer substrate having a first front side and a first rear side;

wherein a plurality of optical metamaterial components is provided in or on the first wafer substrate;

providing a second wafer substrate having a second front side and a second rear side;

wherein a plurality of optical signal-processing components is provided in or on the second wafer substrate;

wafer bonding the first rear side to the second front side (V2) in such a way that at least one associated optical metamaterial component is optically functionally assigned to each optical signal-processing component; and

singulating the bonded first wafer substrate and second wafer substrate into a plurality of chips of optoelectronic elements, which in each case have an optical signal-processing component and at least one associated optical metamaterial component.

An idea underlying the present disclosure is to produce both the optical metamaterial components (flat optics) and the optical signal-processing components at wafer level by semiconductor processes and then to join them by wafer bonding and finally to singulate them.

This advantageously enables smaller tolerances, especially in the Z direction. For the alignment of the two wafer substrates relative to one another in the X and Y directions (laterally), active alignment of only individual components in the array is sufficient, and the other, non-considered components implicitly "inherit" the small alignment error through the active assembly. Thus, the high costs of active assembly can pay off financially and in terms of time if many samples are aligned simultaneously in this manner.

Electrical connections for contacting can be routed in a functional layer of the flat optics if this is required. This is usually the case when optical signal-processing components are contacted from above. Thus, wire bonding can be dispensed with.

Testing of this bonded array of optical assemblies can be carried out before singulation, which in turn is advantageous in terms of process optimization, since each system does not have to be handled individually for this purpose.

The chips are singulated by sawing using standard semiconductor-processing processes. A further advantage of this solution results implicitly from the significantly smaller size/volume of the optical assembly.

Interesting fields of application are any imaging optics and illumination optics in which small installation space and high precision are important, in particular in the fields of consumer electronics, automotive electronics, industrial automation and medical appliances.

According to a preferred further development, the optical metamaterial components are embedded in the first wafer substrate between the first front side and the first rear side. In this way, the optical metamaterial components are particularly well protected, and the front side and rear side of the first wafer substrate can be produced particularly flat.

According to a further preferred further development, before wafer bonding, a plurality of recesses is formed on the first rear side below the optical metamaterial components, which, after wafer bonding, form a particular closed cavity below the associated optical metamaterial component. In this way, a desired free-beam length in the surrounding gas, e.g. air, can be set.

According to a further preferred further development, the first rear side is back-ground or back-etched before the plurality of recesses is formed. In this way, the element size can be reduced.

According to a further preferred further development, a first optical functional layer is formed on the first front side, in which a first part of the plurality of optical metamaterial components is arranged, wherein a second optical functional layer is formed on the first rear side, in which a second part of the plurality of optical metamaterial components is arranged, and wherein in each case one optical metamaterial component on the first front side is vertically aligned with an optical metamaterial component on the first rear side. This enables a particularly compact configuration.

According to a further preferred further development, the optical metamaterial components are metalenses, beam splitters, polarizers or diffraction gratings.

According to a further preferred further development, the first wafer substrate is a glass substrate.

According to a further preferred further development, the second wafer substrate is a semiconductor substrate.

According to a further preferred further development, the optical signal-processing components are optical transceivers, optical receivers or optical transmitters.

### BRIEF DESCRIPTION OF THE DRAWINGS

The present disclosure is explained in more detail below on the basis of the exemplary embodiments indicated in the schematic figures.

FIGS. 1A-1E are schematic partial cross-sectional views for explaining a production method for an optoelectronic element according to a first example embodiment of the present disclosure.

FIGS. 2A-2C are schematic partial cross-sectional views for explaining a production method for an optoelectronic element according to a second example embodiment of the present disclosure.

FIG. 3 is a schematic cross-sectional view of an exemplary optoelectronic element for explaining the problem underlying the present disclosure.

### DETAILED DESCRIPTION OF EXAMPLE EMBODIMENTS

In the figures, identical reference signs denote identical or functionally identical elements.

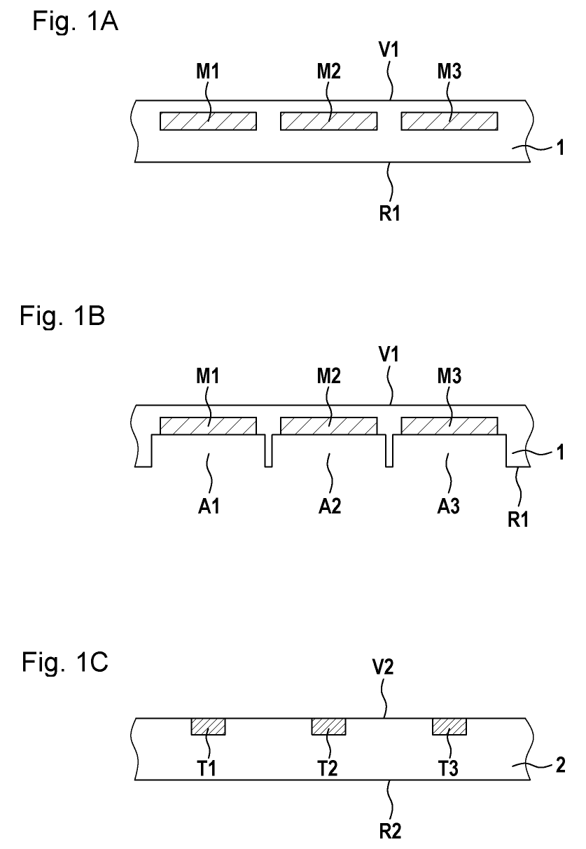

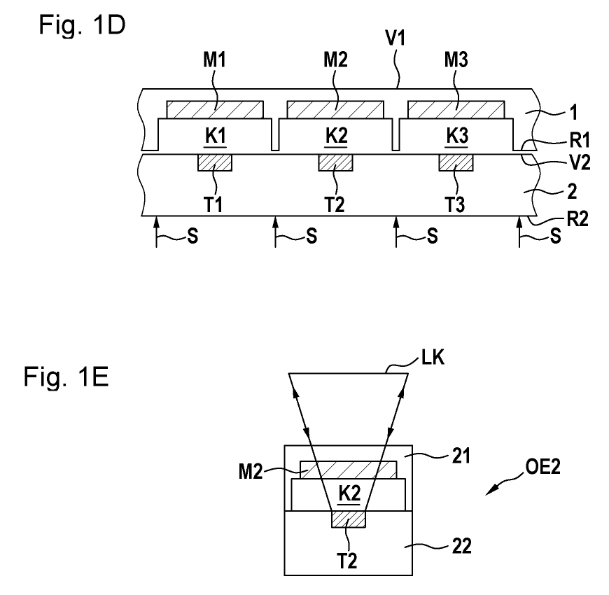

FIGS. 1A-1E are schematic partial cross-sectional views for explaining a production method for an optoelectronic element according to a first embodiment of the present disclosure.

According to FIG. 1A, a first wafer substrate 1 having a first front side V1 and a first rear side R1 is provided, wherein a plurality of optical metamaterial components M1, M2, M2 is provided in the first wafer substrate 1. In the present case, the first wafer substrate 1 is a glass substrate, in which the optical metamaterial components M1, M2, M3 are embedded between the first front side V1 and the first rear side R1. In this example, the metamaterial components M1, M2, M3 are bidirectional metalenses.

According to FIG. 1B, a plurality of discrete recesses A1, A2, A3 is formed on the first rear side R1 below the optical metamaterial components M1, M2, M3 after the first wafer substrate has been thinned on the first rear side R1, e.g. by a grinding and/or etching process, such as a CMP process.

According to FIG. 1C, a second wafer substrate 2 having a second front side V2 and a second rear side R2 is provided, wherein a plurality of optical signal-processing components T1, T2, T3 is provided in the second wafer substrate 2 on the second front side V2. In the present example, the optical signal-processing components T1, T2, T3 are optical transceivers, wherein the second wafer substrate 2 is a semiconductor substrate.

As shown in FIG. 1D, wafer bonding of the first rear side R1 to the second front side V2 is carried out in such a way that at least one associated optical metamaterial component M1, M2, M3 is optically functionally assigned to each optical signal-processing component T1, T2, T3.

After wafer bonding, a particular closed cavity K1, K2, K3 is formed below the associated optical metamaterial component M1, M2, M3 due to the recesses A1, A2, A3.

Singulating the bonded first wafer substrate 1 and second wafer substrate 2 into a plurality of chips of optoelectronic elements, which in each case have an optical signal-processing component and at least one associated optical metamaterial component, is carried out along saw lines S. The chip geometry can be configured virtually arbitrarily.

FIG. 1E shows an optoelectronic element OE2 produced in this way, comprising a first chip region 21, which has the optical metamaterial component M2, which is provided embedded in the first chip region 21.

A second chip region 22 comprises the optical signal-processing component T2, which is provided on the upper side in the second chip region 22.

A light cone LK can thus be sent to and from the transceiver T2.

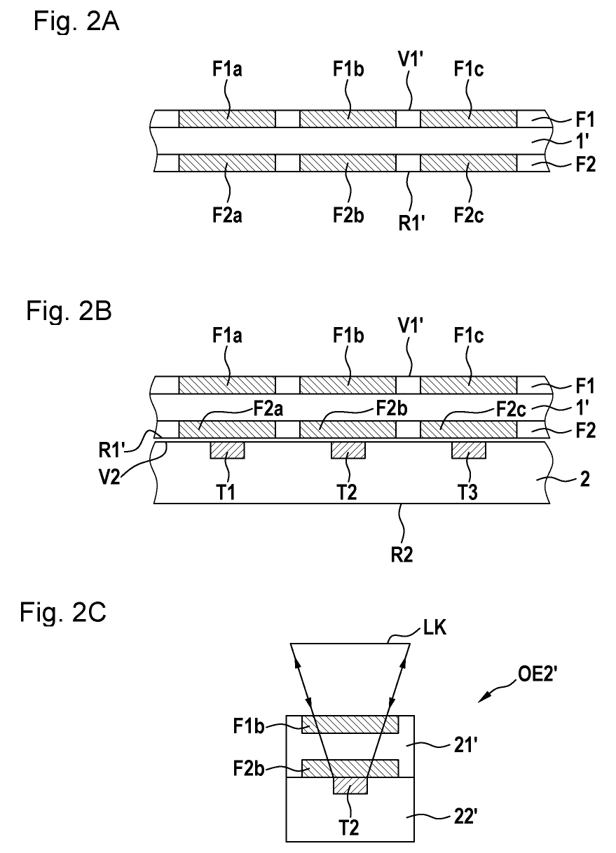

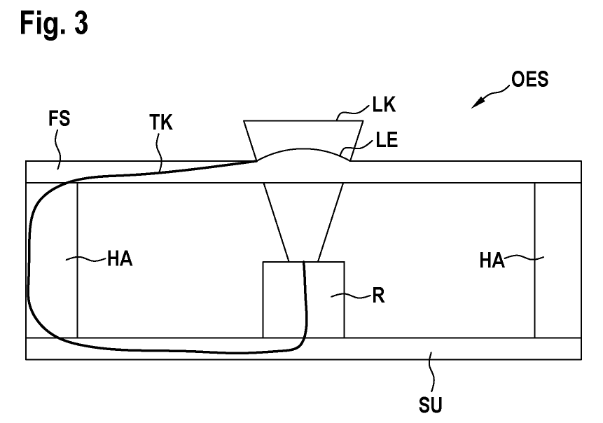

FIGS. 2A-2C are schematic partial cross-sectional views for explaining a production method for an optoelectronic element according to a second embodiment of the present disclosure.

The second embodiment differs from the first embodiment by the structure of the first wafer substrate 1'.

In the second embodiment, according to FIG. 2A, a first optical functional layer F1 is formed on the first front side V1', in which a first part of the plurality of optical metamaterial components F1a, F1b, F1 is arranged, wherein a second optical functional layer (F2) is formed on the first rear side R1', in which a second part of the plurality of optical metamaterial components F2a, F2b, F2c is arranged.

In each case, an optical metamaterial component F1a, F1b, F1c on the first front side V1' is vertically aligned, i.e. in the Z direction, in a surface-overlapping and parallel manner with an optical metamaterial component F1a, F1b, F1c on the first rear side R1'.

FIG. 2B shows the wafer-bonded state of the first wafer substrate 1' and the second wafer substrate 2.

FIG. 2C shows an optoelectronic element OE2' produced in this way, comprising a first chip region 21', which has the optical metamaterial components F1b, F2b, which are provided on opposite sides in the first chip region 21'.

A second chip region 22' comprises the optical signal-processing component T2, which is provided on the upper side in the second chip region 22.

Otherwise, the second embodiment is constructed analogously to the first embodiment.

Although the present disclosure has been completely described above with reference to preferred exemplary embodiments, it is not limited thereto, but can be modified in many ways.

In particular, the field of application of the present disclosure is not limited to the materials and geometries shown.

What is claimed is:

1. A production method for an optoelectronic element, comprising the following steps:
providing a first wafer substrate having a first front side and a first rear side, wherein a plurality of optical metamaterial components is provided in or on the first wafer substrate;
providing a second wafer substrate having a second front side and a second rear side, wherein a plurality of optical signal-processing components is provided in or on the second wafer substrate;
wafer bonding the first rear side to the second front side in such a way that at least one associated optical metamaterial component of the optical metamaterial components is optically functionally assigned to each optical signal-processing component of the optical signal-processing components; and
singulating the bonded first wafer substrate and second wafer substrate into a plurality of chips of optoelectronic elements, each of the chips having an optical signal-processing component and at least one assigned optical metamaterial component.

2. The production method according to claim 1, wherein the optical metamaterial components are embedded in the first wafer substrate between the first front side and the first rear side.

3. The production method according to claim 1, wherein, before the wafer bonding, a respective recess of a plurality of recesses is formed on the first rear side below each respective optical metamaterial component of the optical metamaterial components, which, after the wafer bonding, form a respective closed cavity below the respective optical metamaterial component.

4. The production method according to claim 3, wherein the first rear side is back-ground or back-etched before the plurality of recesses is formed.

5. The production method according to claim 1, wherein a first optical functional layer is formed on the first front side, in which a first part of the plurality of optical metamaterial components is arranged, wherein a second optical functional layer is formed on the first rear side, in which a second part of the plurality of optical metamaterial components is arranged, and wherein in each case an optical metamaterial component of the first part of the plurality of optical metamaterial components on the first front side is vertically aligned with an optical metamaterial component of the second part of the plurality of optical metameterial components on the first rear side.

6. The production method according to claim 1, wherein the optical metamaterial components are one of the following: metalenses, or beam splitters, or polarizers, or diffraction gratings.

7. The production method according to claim 1, wherein the first wafer substrate is a glass substrate.

8. The production method according to claim 1, wherein the second wafer substrate is a semiconductor substrate.

9. The production method according to claim 1, wherein the optical signal-processing components are one of the following: optical transceivers, or optical receivers, or optical transmitters.

10. An optoelectronic element in chip form, comprising:
a first chip region having at least one optical metamaterial component, which is provided in or on the first chip region; and
a second chip region having an optical signal-processing component which is provided in or on the second chip region;
wherein the first chip region is joined to the second chip region by wafer bonding.

11. The optoelectronic element according to claim 10, wherein the optical metamaterial component is embedded in the first chip region.

12. The optoelectronic element according to claim 10, wherein a closed cavity is formed below the optical metamaterial component.

13. The optoelectronic element according to claim 10, wherein a first optical metamaterial component is formed on an upper side of the first chip region and a second optical metamaterial component is formed on a lower side of the first chip region.

14. The optoelectronic element according to claim 10, wherein the at least one optical metamaterial component is one of the following: a metalens, or a beam splitter, or a polarizer, or a diffraction grating.

15. The optoelectronic element according to claim 10, wherein the at least one optical signal-processing component is one of the following: an optical transceiver, or an optical receiver, or an optical transmitter.
